(19) United States
(12) Patent Application Publication
(10) Pub. No.: US 2003/0101412 A1
(43) Pub. Date: May 29, 2003

(54) User aggregation of webpage content

(76) Inventor: Eid Eid, Ottawa (CA)

Correspondence Address: Shapiro Cohen, Station D, P.O. Box 3440, Ottawa, ON, K1P 6P1, CA

(21) Appl. No.: 09/994,639

(22) Filed: Nov. 28, 2001

(51) Int. Cl. G06F 15/00; G09G 5/00

(52) U.S. Cl. 715/513; 345/760

(57) ABSTRACT

Methods and products relating to personalized webpage content aggregation. A target webpage is displayed on a user's machine. The source code of that page is then decoded to determine which content relates to which element on the webpage. The different areas on the webpage are then presented to the user with each element occupying an area. The user then selects at least one area for display on a user web portal. Based on the user selection, the content relating to the element in the user chosen area is then copied and presented on the user web portal. Periodic updates can be accomplished by having the user machine automatically retrieve the chosen content from the target page at user defined intervals and according to selected retrieval rules. This content is then presented to the user web portal.

### FIELD OF THE INVENTION

The present invention relates to webpages and, more specifically, to methods and products which allow users to aggregate content from different webpages for display on their Personalized webportals.

### BACKGROUND OF THE INVENTION

The phenomenal growth not only in interest in but also participation in the Internet in the past few years has highlighted some of the drawbacks of current technology used for accessing Internet web-sites. Currently, web browsers allow users to only access web pages as a whole. If a user wishes to know the latest scores in a sporting event, he or she must visit the page where the scores are presented. Similarly, to access data concerning the day's weather, the user has to visit the webpage displaying the data. This need to visit the webpage is unfortunately necessary even when the user only needs to view a small portion of that page.

While some content providers try to alleviate this problem, their solutions are, at best, limited. Providers such as Yahoo and Netscape can provide users with “personalized” pages that seem to provide users with content or information of their own choosing. However, this is not the case. To use these services a user completes a form indicating his or her areas of interest such as, perhaps, world news, boxing, hockey, and high tech news. The provider then picks items which seem to correspond with the user's areas of interest and provides them to the user's areas of interest and provides them to the user. Unfortunately, the provider's pool of items is chosen and is sifted by the provider and not the user. The user can only choose content that the provider allows him or her to choose. Furthermore, the providers do not provide users with the ability or the freedom to gather content from other webpages. The user is therefore shackled to the provider's webpage if he or she wanted to view the content. The user is not free to choose content from anywhere in the Internet for content that he or she really wants.

Another issue with current technology is the cumbersome methods of keeping current with the content, however little, of a favourite webpage. For the user to keep abreast of changes in the content of his favourite webpage he has to repeatedly visit that webpage or he has to have a service which alerts him when changes on the webpage are detected. Unfortunately such services, when alerting a user, do not alert that user to the specific change in the webpage but merely to the fact that a change has occurred.

These two problems—the need to keep accessing a favourite webpage to view its content even if the content of interest forms a small part of that webpage and the need to keep visiting a page to track changes in that page—can lead to user frustration. A user might need to visit a webpage a few times a day to see if changes have occurred or not. If the page is not readily accessible, such as when the desired content is nested two or three levels inside a website, the user may not even find the desired content if he or she mistakenly clicks on a wrong link. One possible solution is to bookmark pages that a user would want to revisit. However, this does not solve the or original problem of the need to continuously and repeatedly visit a webpage just to access a small portion of that page. Such a need is inconvenient to users who only want a small part of that page without the hassle and bother of the rest of the site page.

Currently, there is no method by which a user can access a single page containing only his own content as chosen by him and as set up by him short of the arduous step of writing and posting his own websites.

From the above, there is a need for a way of allowing users freely to choose, for display on their own machines, only specific portions or specific content of a webpages from any source without the need to display the rest of those webpages.

### SUMMARY OF THE INVENTION

The present invention meets the above need by providing methods and products relating to personalized ==i; webpage content aggregation. A target webpage is displayed on a user's machine. The source code of that page is then decoded to determine which content relates to which element on the webpage. The different areas on the webpage are then presented to the user with each element occupying an area. The user then selects at least one area for display on a user web portal. Based on the user selection, the content relating to the element in the user chosen area is then copied and presented on the user web portal. Periodic updates can be accomplished by having the user machine automatically retrieve the chosen content from the target page at user defined intervals and according to selected retrieval rules. This content is then presented to the user web portal.

In one aspect the present invention provides a method of extracting specific content from a target webpage for display on a user web portal, the method comprising displaying said target webpage, decoding a source code of said target webpage, dividing said target webpage into separate areas, determining which sections of said source code correspond to which area, choosing a selected area of said target webpage containing said specific content, copying content data related to said specific content from said source code and displaying said specific content on said user website using said content data.

In a second aspect, the present invention provides an article of manufacture comprising computer readable media having encoded thereon computer readable and executable code comprising:

a retrieval module for retrieving source webpage code from a server;

a parsing module for parsing said webpage code into specific elements and element types;

a user interface module for presenting to a user a webpage defined by said webpage code such that the user can choose specific areas which has content in said webpage for extraction;

a decoding module for associating said specific areas with said specific elements; and

a presentation module for presenting content contained in said specific areas to said user in a user page.

In a third aspect the present invention provides, a communications signal transmitted from a server, said signal having encoded thereon computer readable and executable code comprising:

a retrieval module for retrieving source webpage code from a server;

a parsing module for parsing said webpage code into specific elements and element types;

a user interface module for presenting to a user a webpage defined by said webpage code such that the user can choose specific areas which have content in said webpage for extraction;

a decoding module for associating said specific areas with said specific elements; and

a presentation module for presenting content contained in said specific areas to said user in a user page.

In a fourth aspect the present invention provides a method of providing user selected content to a user in a user webpage, said method comprising:

displaying a target webpage to a user;

extracting content contained in at least one user selected area of said target webpage; and

displaying said content at said user webpage.

### BRIEF DESCRIPTION OF THE DRAWINGS

A better understanding of the invention may be obtained by reading the detailed description of the invention below, in conjunction with the following drawings, in which:

FIG. 1 is an illustration of a simple webpage having multiple different elements;

FIG. 2 is a block diagram of software components and the workflow between them utilizing practising an aspect of the invention; and

FIG. 3 is a flowchart of the steps taken in extracting content from a target website.

### DETAILED DESCRIPTION

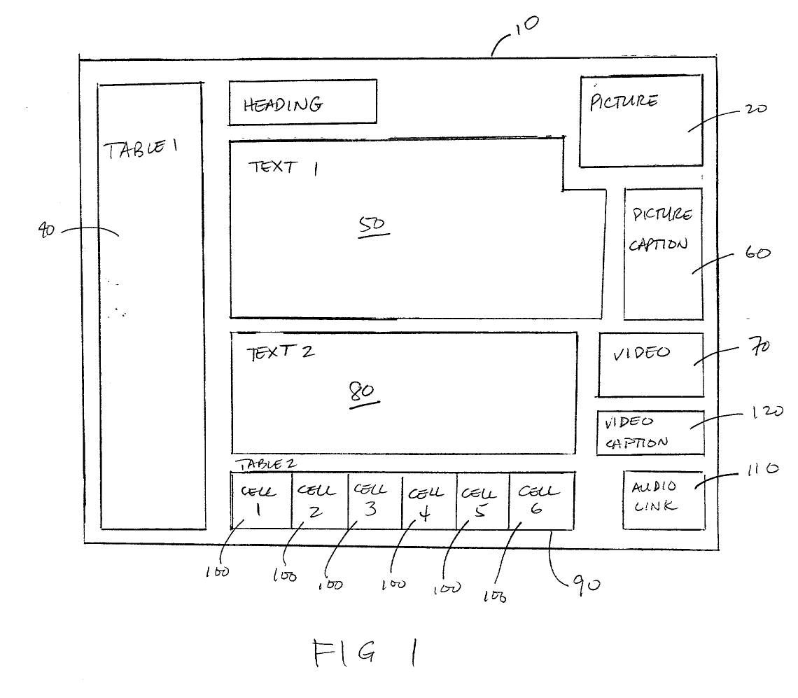

Referring to FIG. 1, a typical webpage layout 10 having multiple different elements is illustrated. As can be seen, the elements illustrated are a picture box 20, heading 30, a first table 40, a first text box 50, a picture caption 60, a video clip box 70, a second text box 80, a second table 90 with multiple cells 100, an audio clip box 110, and a video caption 120.

Typically, the first table 40 is a navigational menu to be used by the user to navigate the web site while the audio clip box 110 and the video clip box 120, when activated, launches a browser plug-in that retrieves and plays the multimedia file pointed to in the box. The picture caption box 60 and the video caption box 120 contain text that either matches or explains the video clip in the video clip box 70 and the picture in the picture box 20.

The picture box 20 contains a picture in a generally accepted file format such as .jpg or .gif. The webpage source code would follow the format of:

POSITION

ELEMENT DEFINE BEGIN

ELEMENT CONTENT

ELEMENT DEFINE END

for each element. The element contents field may have the contents itself (if a text element or a table or cell element) or a link to the contents (if the element were a multimedia element). The link would point to a static multimedia file in an acceptable format such as .avi, .mp3, mpg, or .asf. Also for a multimedia file, the element contents field would contain the parameters of the file itself such as its size in pixels, if it is a movie file. On the other hand, if the content is a dynamically changing content such as a live video feed, the element contents field would have not only the pixel size of the video but also the link to where the feed may be retrieved.

It should be noted that it is common to reference a static picture file in this field for a multimedia file. This way the user would know what the multimedia content is.

For an audio clip box, the element contents field would have a link to an audio file and activating the link would launch a plugin which can handle the type of audio file referred to.

The picture box 20 would also have a link to a picture file which is displayed on the page inside the picture box 20.

For text boxes, the element contents field would have, ideally, the text to be portrayed on the page. However, it is also common that a link to a text file be referenced in the element contents field. Furthermore, the element contents field would have the formatting characteristics of the text such as font, size and possibly colour.

For the table elements, the element contents field would contain similar data such as formatting details, links and/or actual contents. As an example, if table box 40 were used as a navigational menu, the element contents field would have links to the other parts of the website along with suitable text describing those website parts pointed to, along with the formatting characteristics of the text. The second table 90, on the other hand, would have data in the element contents field that define the contents of each cell 100, including text/number formatting data.

The heading element 30 would simply be treated as a specialized text element with perhaps some special formatting characteristic.

Based on the above, the source code for the webpage layout in FIG. 1 would have a general format as follows:

POSITION

TABLE DEFINE BEGIN

TABLE DEFINE END

POSITION

HEADING DEFINE BEGIN

HEADING CONTENTS

HEADING DEFINE END

POSITION

PICTURE DEFINE BEGIN

PICTURE CONTENTS

PICTURE DEFINE END

POSITION

TEXT DEFINE BEGIN

TEXT CONTENTS (TEXT 1)

TEXT DEFINE END

POSITION

TEXT DEFINE BEGIN

TEXT CONTENTS (PICTURE CAPTION)

TEXT DEFINE END

POSITION

TEXT DEFINE BEGIN

TEXT CONTENTS (TEXT 2)

TEXT DEFINE END

POSITION

MULTIMEDIA DEFINE BEGIN

MULTIMEDIA CONTENTS (VIDEO)

MULTIMEDIA DEFINE END

POSITION

TEXT DEFINE BEGIN

TEXT CONTENTS (VIDEO CAPTION)

TEXT DEFINE END

POSITION

TABLE DEFINE BEGIN

TABLE CONTENTS (TABLE 2)

CELL 1 CONTENTS

CELL 2 CONTENTS

CELL 3 CONTENTS

CELL 4 CONTENTS

CELL 5 CONTENTS

CELL 6 CONTENTS

TABLE DEFINE END

POSITION

MULTIMEDIA DEFINE BEGIN

MULTIMEDIA CONTENTS (AUDIO)

MULTIMEDIA DEFINE END

It should be clear that the above is only given as a general template followed by most static webpages and that specific details will be different.

It should also be clear that while only five types of boxes are illustrated and explained (table, heading, text, picture and multimedia boxes), others which may be hybrids of the 5 types are possible.

To extract the contents of these boxes, the source code would have to be parsed, extraneous data discarded, content indicators recognized, and content copied. Accomplishing this through the use of a parser a lexical analyser program that automatically divides source code into keywords key symbols, tags, tag names, tag values, and data, is ideal.

A parser, such as the well known program LEX, can be configured to recognize specific keywords, phrases, and symbols that make up a lexicon for a specific computer language. For the pseudo source code given above, the parser would be programmed to recognize the following keywords or phrases:

TABLE DEFINE BEGIN

TABLE DEFINE END

HEADING DEFINE BEGIN

HEADING DEFINE END

PICTURE DEFINE BEGIN

PICTURE DEFINE END

TEXT DEFINE BEGIN

TEXT DEFINE END

MULTIMEDIA DEFINE BEGIN

MULTIMEDIA DEFINE END

Also, the parser would be configured to recognize text formatting symbols and words, along with whatever symbols or words are used to define the position of a box. The parser would also be configured to recognize specific string segments to find filename types. This way, if a link is to a file with an extension of mpg, then it can be identified as a movie file of the of MPEG format.

Once the parser separates the terms in the source code into specific categories and associates then with each other (e.g. TABLE DEFINE BEGIN is associated with its own table contents) then it is simple matter to determine which portion of the webpage is associated with which content. Different areas of the webpage can then be highlighted and presented to the user who will then select which content he or she wishes to extract.

With the content selected, the extraction process is straightforward. The area selected by the user as containing the desired content is already associated with that content through the parsing process. The content associated with the selected area is then copied from the parser output.

It should be noted that most parser outputs are in the form of parse trees with specific keywords associated with their data. By simply finding the relevant keyword or symbol and travelling down the parse tree, the content data can be found. This data or the content it points to can then be copied for display on the user web portal.

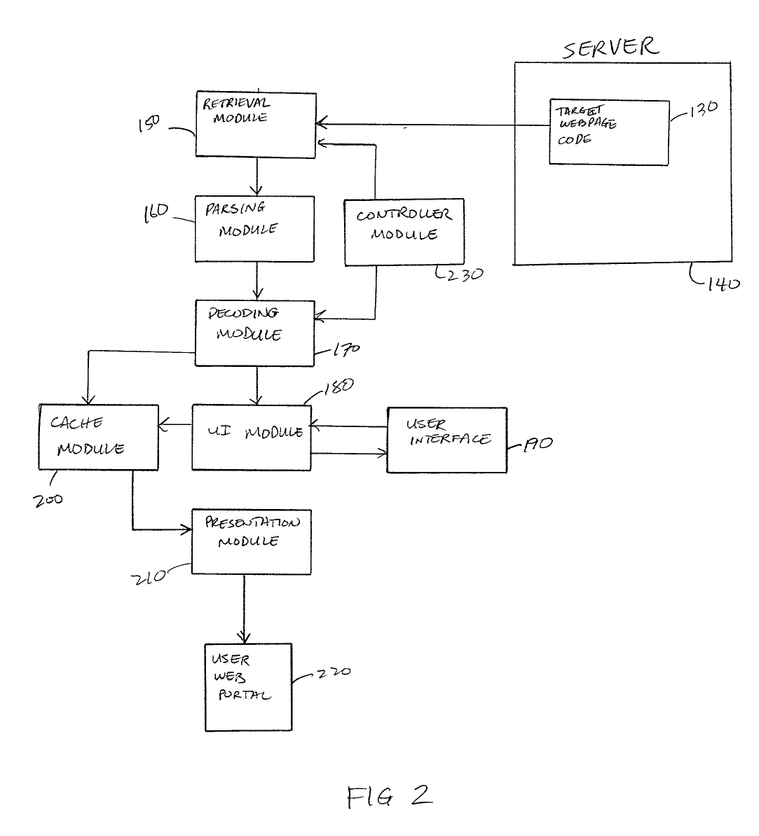

To further explain, FIG. 2 illustrates a block diagram of the software modules used in such a system along with the workflow throughout.

As can be seen, the source code of the target webpage 130 residing in a server 140 is retrieved by a retrieval module 150. The retrieval module then passes the source code to a parsing module 160 which parses the code. The output of the parsing module 160 is received by a decoding module 170 that determines the type of content associated with each element box. The decoding module also determines the limits or positions of each element box.

With the element boxes decoded and their contents tagged and associated with them, the source code is fed into a UI (user interface) module 180. The UI module is simply a regular browser with some extra logic built in. This extra logic takes the output of the decoding module (specifically the area definitions) and highlights each area differently. This can be done by either outlining an actual box around the area or by changing the background colour of each area. Either way, the UI module differentiates each area from one another. The highlighted/differentiated webpage is then presented to the user using the user interface 190.

The user then chooses which area he or she wishes extracted. This can be done by clicking on the area or by other well known suitable means. With the area chosen, the user can then command his machine to place the content in a separate window in his web portal display. Ideally, each separate content will be allocated a separate window in the portal. Furthermore, it would be advantageous if the user can format the characteristics of the content as it would appear in the window at this time. This step may be derived as text content may or may not be stripped of formatting characteristics when it is extracted from the parse tree.

Once the user has chosen the content, his choice and its characteristic are then sent back to the UI module 180 for subsequent relaying to a cache module 200. The cache module 200 caches the content on the user's machine so that the content can be easily retrieved. If the content is merely text located in the source code, the text is extracted from the parse tree or the source code and placed in the cache. If the content is a file (whether a picture file for a multimedia file) located somewhere other than the user's machine, the link to that file is the data extracted from the source code and placed in the parse tree. With the link, the cache module can then retrieve the file pointed to and save that file in the cache. If the content is a live feed, the cache module can either cache the incoming feed into a temporary file for later retrieval by the user or the cache module can pass the feed data on the next module to handle.

The next module in the chain is the presentation module 210. This module retrieves the cached content from the cache module if and when needed and presents it to the user through the user web portal 220. The presentation module 210 therefore performs the actual work of calling up any plugins required by the content. As an example, if the content is a video file, the presentation module 210 launches a video viewer plug in for the user portal 220 and shows the video content through that viewer. The same is true if the content is an audio file or a simple text file to be continuously scrolled through the user web portal.

Another module, a controller module 230, handles refreshing the content. The user can designate specific retrieval rules which may include a specific time interval between refreshes. Once the interval expires, the controller module 230 commands the retrieval module 150 to retrieve the latest version of the target webpage code. This code is parsed by the parsing module 160 and decoded by the decoding module 170. However, since the controller module 230 already knows the specific position, placement, or location of the content within the page (e.g. Table 1 cell 5 or video box 1 or text box 2) then the content can be automatically extracted without user intervention. Once extracted, the content is sent to the cache module 200 where it can be retrieved by the presentation module 210. Other retrieval rules may relate to automatic logins to sites requiring user logins where the site contains content desired by the user. The refresh may also be controlled not by a specific time interval but explicitly by the user—the user may explicitly request a refresh or the refresh may be set to occur at the user's login to the account.

The next time the presentation module 210 retrieves the content and presents it to the user web portal 220, what is presented is the updated content—assuming the content from the target webpage has been updated by the webmaster.

It should be noted that of the software components noted above, all reside in the user's designated space which can be located at the user server or cached on his local machine. This allows the user to access his personalized page from any compatible machine connected to the user server. To further explain the above, of the components in FIG. 2, the retrieval module 150, parsing module 160, decoding module 170, UI module 180, cache module 200, presentation module 210, user web portal 220, and controller module 230, can all be located on the user server or cached in a user's local machine. User interface 190 is located on a user's local machine. To further clarify, it should be noted that server 140 is different from the user server which would contain the different modules listed above. The user server would be a server which the user would log on to using user interface 190 so that the user could access his personalized page from any computer. Similarly, the modules listed above can be contained on the user's own local machine.

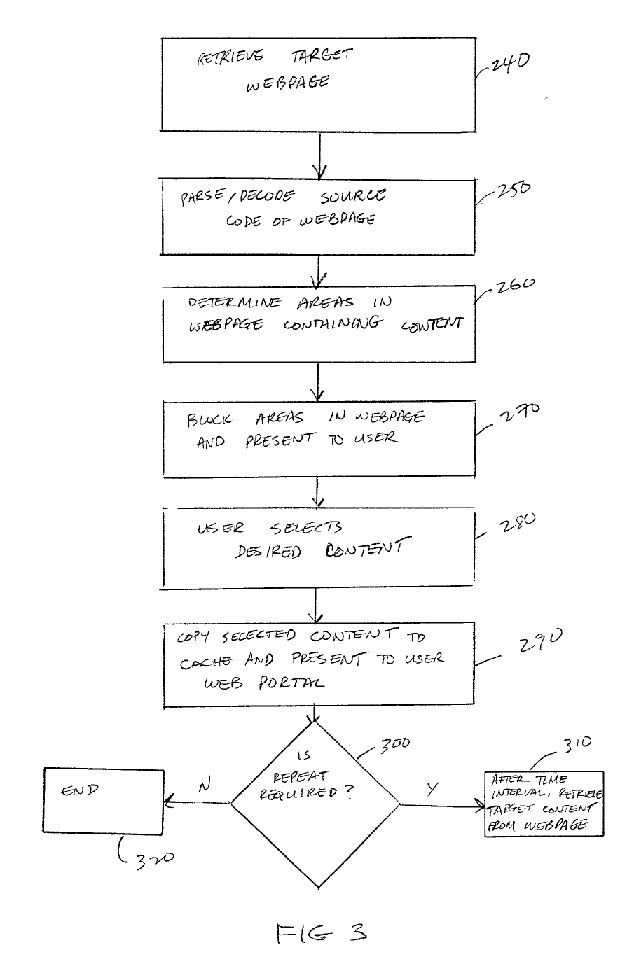

The sequence of functions in this aspect of the invention is illustrated in the flowchart of FIG. 3. The first step in the process is that of retrieving the target webpage code (step 240). This source code is then parsed and decoded (step 250) the areas covered by the content is then determined (step 260). These areas are blocked off in the webpage and shown to the user (step 270) the user than selects the content what he or she wants extracted (step 280). This content is copied to a cache and presented to that user's web portal (step 280). A decision 300 is then made as to whether refreshes are required based on user preference. If so, after a time interval the target webpage code is retrieved once again and the specific content extracted (step 310). If no refresh is desired, then the process ends (step 320).

The invention can be embodied in software encoded on computer readable media such as storage disks. Such software can then be encoded and transmitted through a communications signal sent from a server to a user.

A person understanding the above-described invention may now conceive of alternative designs, using the principles described herein. All such designs which fall within the scope of the claims appended hereto are considered to be part of the present invention.

We claim:

1. A method of extracting specific content from a target webpage for display on a user web portal, the method comprising:
a) displaying said target webpage;
b) decoding a source code of said target webpage;
c) dividing said target webpage into separate areas;
d) determining which sections of said source code corresponds to each area;
e) choosing a selected area of said target webpage containing said specific content;
f) copying content data related to said specific content from said source code; and
g) displaying said specific content on said user website using said content data.

2. A method as in claim 1 wherein step b) is accomplished by parsing said source code.

3. A method as in claim 1 wherein step d) is accomplished by searching said source code for specific keywords which delimit content fields.

4. A method as in claim 3 wherein said specific keywords delimit links to multimedia files.

5. A method as in claim 3 wherein said specific keywords delimit links to multimedia files.

6. A method as in claim 5 wherein said content data is a link pointing to at least one multimedia file.

7. A method as in claim 4 wherein said content data is text contained in said text fields.

8. An article of manufacture comprising computer readable media having encoded thereon computer readable and executable code comprising:
a retrieval module for retrieving source webpage code from a server;
a parsing module for parsing said webpage code into specific elements and element types;
a user interface module for presenting to a user a webpage defined by said webpage code such that the user can choose specific areas which has content in said webpage for extraction;
a decoding module for associating said specific areas with said specific elements; and
a presentation module for presenting content contained in said specific areas to said user in a user page.

9. An article of manufacture as in claim 8 wherein said code includes a controller module which commands said retrieval module to retrieve webpage code at specific times.

10. An article of manufacture as in claim 8 wherein said code includes a cache module for caching said content contained in said specific areas.

11. A communications signal transmitted from a server, said signal having encoded thereon computer readable and executable code comprising:
a retrieval module for retrieving source webpage code from a server;
a parsing module for parsing said webpage code into specific elements and element types;
a user interface module for presenting to a user a webpage defined by said webpage code such that the user can choose specific areas which has content in said webpage for extraction;
a decoding module for associating said specific areas with said specific elements; and
a presentation module for presenting content contained in said specific areas to said user in a user page.

12. A signal as in claim 11 wherein said code includes a controller module which commands said retrieval module to retrieve webpage code at specific times.

13. A signal as in claim 11 said code includes a cache module for caching said content contained in said specific areas.

14. A method of providing user selected content to a user in a user webpage, said method comprising:
displaying a target webpage to a user;
extracting content contained in at least one user selected area of said target webpage; and
displaying said content at said user webpage.
